(19) United States
(12) Patent Application Publication
(10) Pub. No.: US 2026/0121262 A1
(43) Pub. Date: Apr. 30, 2026

(54) BATTERY MODULE

(71) Applicant: SAMSUNG SDI CO., LTD., Yongin-si (KR)

(72) Inventor: DONG BOK YANG, Yongin-si (KR)

(21) Appl. No.: 19/202,328

(22) Filed: May 8, 2025

(30) Foreign Application Priority Data
Oct. 31, 2024 (KR) 10-2024-0152532

(51) Int. Cl. H01M 50/583; H01M 50/503; H01M 50/522

(52) U.S. Cl. CPC H01M 50/583; H01M 50/503; H01M 50/522

(57) ABSTRACT

A battery module include a plurality of secondary batteries comprising terminal parts and disposed in one direction; a plurality of first connection tabs connecting the secondary batteries and an external power circuit; a plurality of second connection tabs connecting the plurality of secondary batteries; and a housing for fixing the plurality of secondary batteries, the first connection tab comprises a first short circuit part comprising the first cutting part, the second connection tab comprises a second short circuit part including the second cutting part, and a size of the first connection tab is greater than a size of the second connection tab.

### CROSS-REFERENCE TO THE RELATED APPLICATION

The present application claims priority to and the benefit under 35 U.S.C §119(a)-(d) of Korean Patent Application No. 10-2024-0152532, filed in the Korean Intellectual Property Office on Oct. 31, 2024, the entire disclosure of which is incorporated herein by reference.

### BACKGROUND

### 1. Field

The present disclosure relates to a battery module.

### 2. Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

The information disclosed in this section is provided only for enhancement of understanding of the background of the disclosure and therefore it may contain information that does not form the prior art.

### SUMMARY

Embodiments provide a battery module having improved safety features.

The battery module according to embodiments include a plurality of secondary batteries comprising terminal parts and disposed in one direction; a plurality of first connection tabs connecting the secondary batteries and an external power circuit; a plurality of second connection tabs connecting the plurality of secondary batteries; and a housing for fixing the plurality of secondary batteries, the first connection tab comprises a first short circuit part comprising the first cutting part, the second connection tab comprises a second short circuit part including the second cutting part, and a size of the first connection tab is larger than a size of the second connection tab.

The first connecting tab has a first width in a region other than the first short circuit part, the first short circuit part has a 1a width formed by the first cutting part, and the 1a width is smaller than the first width.

The second connecting tab has a second width in a region other than the second short circuit part, the second short circuit part has a 2a width formed by the second cutting part, and the 2a width is smaller than the second width.

The first width is larger than the second width.

The 1a width is larger than the 2a width.

The first connecting tab has a first length, and a length of the first short circuit part is 5% to 10% of the first length.

The second connecting tab has a second length, and a length of the second short circuit part is 5% to 10% of the second length.

The first length and the second length are different.

At least one of the second connecting tabs of the plurality of second connecting tabs comprises a short circuit part.

The first connecting tab has a first thickness, the first short circuit part has a 1a thickness, and the 1a thickness is smaller than the first thickness.

The second connecting tab has a second thickness, the second short circuit part has a 2a thickness, and the 2a thickness is smaller than the second thickness.

The first thickness is greater than the second thickness, and the 1a thickness is greater than the 2a thickness.

The 1a thickness varies while extending in the longitudinal direction of the first connecting tab, and the 2a thickness varies while extending in the longitudinal direction of the second connecting tab.

At least one of the first connecting tab or the second connecting tab comprises a plurality of short circuit parts.

A width or thickness of the plurality of short circuit parts are different.

The battery module according to embodiments include a plurality of secondary batteries comprising terminal parts and disposed in one direction; a plurality of first connection tabs connecting the secondary batteries to an external power circuit; a plurality of second connection tabs connecting the plurality of secondary batteries; and a housing for fixing the plurality of secondary batteries, at least one of the first connection tab or the second connection tab comprises a variable resistance region, and an electrical resistance of the variable resistance region is different from an electrical resistance of the other regions.

At least one of the first connecting tab and the second connecting tab comprises a first region and a second region, the electrical resistances of the first region and the second region are different, and the first region comprises the resistance variable region.

The first region comprises a first metal and a second metal, the second region comprises the first metal, and the first metal and the second metal comprise at least one of aluminum, copper, nickel, or an alloy thereof.

The first region comprises a first-first region and the first-second region

A length of the first-first region is longer than a length of the first-second region.

Embodiments of the present disclosure provide a battery module, including: a plurality of a secondary battery including a terminal part and arranged in one direction; a plurality of a first connection tab connecting the plurality of the secondary battery to an external power circuit; a plurality of a second connection tab connecting the plurality of the secondary battery; and a housing fixing the plurality of the secondary battery, wherein the first connection tab includes a first short circuit part including the first cutting part, wherein the second connection tab includes a second short circuit part including a second cutting part, and wherein the first connection tab has a size greater than a size of the second connection tab.

In some embodiments, the first connecting tab has a first width in a region other than the first short circuit part, wherein the first short circuit part has a 1a width formed by the first cutting part, and wherein the 1a width is less than the first width.

In some embodiments, the second connecting tab has a second width in a region other than the second short circuit part, wherein the second short circuit part has a 2a width formed by the second cutting part, and wherein the 2a width is less than the second width.

In some embodiments, the first width is greater than the second width.

In some embodiments, the 1a width is greater than the 2a width.

In some embodiments, the first connecting tab has a first length, and wherein a length of the first short circuit part is 5% to 10% of the first length.

In some embodiments, the second connecting tab has a second length, and wherein a length of the second short circuit part is 5% to 10% of the second length.

In some embodiments, the first length and the second length are different.

In some embodiments, at least one of the plurality of the second connecting tab comprises a short circuit part.

In some embodiments, the first connecting tab has a first thickness, wherein the first short circuit part has a 1a thickness, and wherein the 1a thickness is less than the first thickness.

In some embodiments, the second connecting tab has a second thickness, wherein the second short circuit part has a 2a thickness, and wherein the 2a thickness is less than the second thickness.

In some embodiments, the first thickness is greater than the second thickness, and wherein the 1a thickness is greater than the 2a thickness.

In some embodiments, the 1a thickness varies while extending in a longitudinal direction of the first connecting tab, and wherein the 2a thickness varies while extending in a longitudinal direction of the second connecting tab.

In some embodiments, at least one of the plurality of the first connecting tab or at least one of the plurality of the second connecting tab comprises a plurality of a short circuit part.

In some embodiments, a width or a thickness of any two or more of the plurality of the short circuit part are different.

Embodiments of the present disclosure provide a battery module including: a plurality of a secondary battery including a terminal part and arranged in one direction; a plurality of a first connection tab connecting the plurality of the secondary battery to an external power circuit; a plurality of a second connection tab connecting the plurality of the secondary battery; and a housing fixing the plurality of the secondary battery, wherein the first connection tab or the second connection tab includes a variable resistance region, and wherein an electrical resistance of the variable resistance region is different from an electrical resistance of other regions of the first connection tab or the second connection tab.

In some embodiments, the first connecting tab or the second connecting tab further includes a first region and a second region, wherein an electrical resistance of the first region and an electrical resistance of the second region are different, and wherein the first region includes the resistance variable region.

In some embodiments, the first region includes a first metal and a second metal,
wherein the first metal and the second metal are different, wherein the second region includes the first metal, and wherein each of the first metal and the second metal include aluminum, copper, or nickel.

In some embodiments, the first region includes a first-first region and the first-second region.

In some embodiments, a length of the first-first region is greater than a length of the first-second region.

### BRIEF DESCRIPTION OF THE DRAWINGS

The accompanying drawings, which are incorporated in this specification, illustrate preferred embodiments and serve to further illustrate the technical ideas of the disclosure in conjunction with the detailed description of exemplary embodiments that follows, and the disclosure is not to be construed as limited to what is shown in such drawings. In the drawings:

FIG. 1 is a perspective view showing a battery module according to an embodiment of the present disclosure.

FIG. 2(a) and 2(b) are top views showing a connection tab of the battery module according to an embodiment of the present disclosure.

FIG. 3(a) and 3(b) are top views showing the connection tab of the battery module according to an embodiment of the present disclosure.

FIG. 4 is a cross-sectional view taken along the A-A′ section of FIG. 3 an embodiment of the present disclosure.

FIG. 5 is a cross-sectional view taken along the B-B′ section of FIG. 3 an embodiment of the present disclosure.

FIG. 6 is a cross-sectional view taken along the A-A′ section of FIG. 3 an embodiment of the present disclosure.

FIG. 7 is a cross-sectional view taken along the B-B′ section of FIG. 3 an embodiment of the present disclosure.

FIG. 8(a) and 8(b) are top views showing the connection tab of the battery module according to an embodiment of the present disclosure.

FIG. 9(a) and 9(b) are top views showing the connection tab of the battery module according to an embodiment of the present disclosure.

FIG. 10(a) and 10(b) are top views showing the connection tab of the battery module according to an embodiment of the present disclosure.

FIG. 11 is a cross-sectional view taken along the C-C′ section of FIG. 10 according to an embodiment of the present disclosure.

FIG. 12 is a cross-sectional view taken along the D-D′ section of FIG. 10 according to an embodiment of the present disclosure.

FIG. 13 Is a top view showing the connection tab of the battery module according to an embodiment of the present disclosure.

FIG. 14 is a cross-sectional view taken along the C-C′ section of FIG. 10 according to an embodiment of the present disclosure.

FIGS. 15 and 16 are cross-sectional views taken along the A-A′ section of FIG. 3 according to an embodiment of the present disclosure.

FIGS. 17, 18, and 19 are cross-sectional views taken along the C-C′ section of FIG. 10 according to an embodiment of the present disclosure.

FIGS. 20, 21, and 22 show secondary batteries of various geometries according to an embodiment of the present disclosure.

FIGS. 23 and 24 are perspective views showing a battery pack including battery modules according to an embodiment of the present disclosure.

FIGS. 25 and 26 are, respectively, a perspective view and a side view showing a vehicle including battery packs according to an embodiment of the present disclosure.

### DETAILED DESCRIPTION OF EXEMPLARY EMBODIMENTS

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed”between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

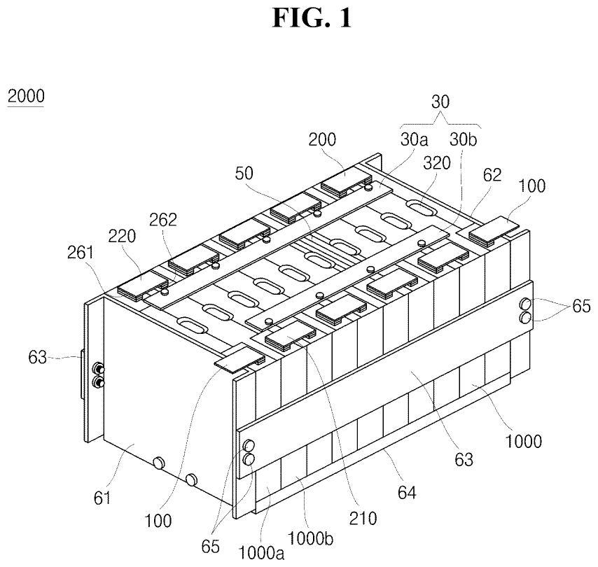

FIG. 1 is a perspective view showing a battery module. Referring to FIG. 1, the battery module 2000 include terminal parts 261 and 262, a plurality of secondary battery 1000 arranged in one direction, a first connection tab 100 connecting the secondary battery 1000 and an external power circuit, a second connection tab 200 connecting a secondary battery 1000a to an adjacent secondary battery 1000b, and a protection circuit module 30 having one end connected to the second connection tab 200. The protection circuit module 30 may include a battery management system (BMS). Further, the second connection tab 200 may include a body portion in contact with the terminal parts 261 and 262 between the adjacent secondary battery 1000a and 1000b and an extension portion extending from the body portion and connected to the protection circuit module 30. The second connection tab 200 may be, for example, a bus bar.

The first connection tab 100 and the second connection tab 200 may be connected to the terminal parts 261 and 262. In some embodiments, the terminal parts 261 and 262 may have different polarities. In some embodiments, the terminal parts may include a positive terminal part 261 and a negative terminal part 262.

The first connection tab 100 may be connected to the terminal part of the outermost secondary battery. In some embodiments, the first connection tab 100 may be connected to the positive terminal part of the first outermost secondary battery and the negative terminal portion of the second outermost secondary battery.

The secondary batteries may be connected by the second connection tab 200. In some embodiments, the secondary batteries may be connected in series, in parallel, or in series/parallel by the second connection tab 200. The second connecting tab 200 may include a plurality of connecting tabs. In some embodiments, the second connecting tab 200 may be connected to terminal parts of the same polarity of adjacent secondary batteries. In some embodiments, the second connecting tab 200 may be connected to terminal parts of different polarities of adjacent secondary batteries.

The secondary battery 1000 may include secondary batteries of various shapes. In some embodiments, the secondary battery may include a cylindrical, pouch, or prismatic secondary battery. Terminal parts 261 and 262 electrically connected to the second connection tab 200 and a vent 320 as a discharge passage for gas generated inside the battery case may be provided on one side of (e.g., an upper side of) the secondary battery 1000. The terminal parts 261 and 262 of the adjacent secondary battery 1000a and 1000b may be electrically connected to each other in series or parallel by the second connection tab 200. Although a serial connection has been described, the connection structure is not limited thereto, and various connection structures may be employed as desired or necessary. In addition, the number and arrangement of secondary battery is not limited to the structure shown in FIG. 1 and may be changed as desired or necessary.

The plurality of secondary batteries 1000 may be arranged in (e.g., may be stacked in) one direction so that the wide surfaces of the secondary batteries 1000 face each other, and the plurality of secondary batteries 1000 may be fixed by the housings 61, 62, 63, and 64. The housings 61, 62, 63, and 64 may include a pair of end plates 61 and 62 facing the wide surfaces of the secondary battery batteries 1000 and a side plate 63 and a bottom plate 64 connecting the pair of end plates 61 and 62 to each other. The side plate 63 may support side surfaces of the secondary batteries 1000, and the bottom plate 64 may support bottom surfaces of the secondary batteries 1000. In addition, the pair of end plates 61 and 62, the side plate 63 and the bottom plate 64 may be connected by bolts 65 and/or any other suitable fastening members and methods known to those of ordinary skill in the art.

The protection circuit module 30 may have electronic components and protection circuits mounted thereon and may be electrically connected to the second connection tabs 200. The protection circuit module 30 includes a first protection circuit module 30a and a second protection circuit module 30b extending along the direction in which the plurality of secondary batteries 1000 are arranged in different locations. The first protection circuit module 30a and the second protection circuit module 30b may be spaced from each other at a suitable or desired interval (e.g., a predetermined interval) and arranged parallel to each other to be electrically connected to adjacent second connection tabs 200, respectively. For example, the first protection circuit module 30a extends on one side of the upper portion of the plurality of secondary batteries 1000 along the direction in which the plurality of secondary batteries 1000 are arranged, and the second protection circuit module 30b extends to the other upper side of the plurality of secondary batteries 1000 along the direction in which the plurality of secondary batteries 1000 are arranged. The second protection circuit module 30b may be spaced from the first protection circuit module 30a at a suitable or desired interval (e.g., a predetermined interval) with the vents 320 interposed therebetween but may be disposed parallel to the first protection circuit module 30a. As such, the two protection circuit modules are spaced from each other side-by-side along the direction in which the plurality of secondary batteries 1000 are arranged, thereby reducing or minimizing the area of the printed circuit board (PCB) constituting the protection circuit module. By separately configuring the protection circuit module into two protection circuit modules, unnecessary PCM area can be reduced or minimized. In addition, the first protection circuit module 30a and the second protection circuit module 30b may be connected to each other by a conductive connection member 50. One side of the conductive connection member 50 is connected to the first protection circuit module 30a, and the other side thereof is connected to the second protection circuit module 30b so that the two protection circuit modules 30a and 30b can be electrically connected with each other.

The connection may be performed by any one of soldering, resistance welding, laser welding, projection welding and/or any other suitable connection methods known to those of ordinary skill in the art.

In addition, the connection member 50 may be or include, for example, an electric wire. In addition, the connection member 50 may be made of or include a material having elasticity or flexibility. By the connecting member 50, it may be possible to check and manage whether the voltage, temperature, and/or current of the plurality of secondary battery 1000 are normal or within a desired range. For example, the information received by the first protection circuit module from connection tabs adjacent to the first protection circuit module, such as voltage, current, and/or temperature, and the information received from connection tabs adjacent to the second protection circuit module, such as voltage, current, and/or temperature, may be integrated and managed by the protection circuit module through the connection member 50.

In addition, when a secondary battery 1000 swells, shocks may be absorbed by the elasticity or flexibility of the connection member 50, thereby hindering or preventing the first and second protection circuit modules 30a and 30b from being damaged.

In addition, the shape and structure of the connection member 50 is not limited to the shape and structure shown in FIG. 1.

Because the protection circuit module 30 is provided as the first and second protection circuit modules 30a and 30b, the area of the PCB constituting the protection circuit module can be reduced or minimized, and the space inside the battery module can be secured, which improves work efficiency by facilitating a fastening work for connecting the connection tab 20 and the protection circuit module 30 and repair work when an abnormality is detected in the battery module.

The battery module may include the first connection tab 100 and the second connection tab 200. The current of the battery module may flow through the first connection tab 100 and the second connection tab 200. In some embodiments, the current flowing from the external power circuit to the secondary battery may flow through the first connection tab 100. In some embodiments, the current flowing to the plurality of secondary batteries may flow through the second current tab 200.

If an overcurrent flows into the battery module, the temperature of the battery module may increase. Accordingly, the internal temperature and pressure of the secondary battery may increase due to the vaporization of the electrolyte. A fire may occur in the secondary battery and the flame may be transmitted to an adjacent secondary battery, causing the battery module to explode.

In some embodiments, an overcurrent exceeding the allowable current may flow to the secondary battery through the first connecting tab. In some embodiments, an overcurrent exceeding the allowable current may flow to an adjacent secondary battery through the second connecting tab.

Embodiments of the present disclosure may control the shape or material of the first connecting tab and the second connecting tab.

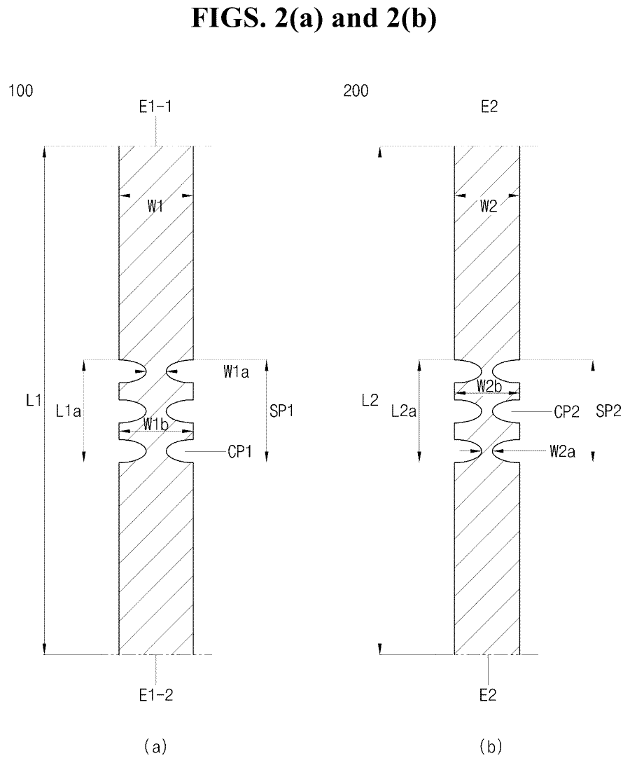

FIG. 2(a) and 2(b) are top views showing a connection tab of the battery module according to an embodiment of the present disclosure. The connection tab may include a short circuit part.

In some embodiments, referring to FIG. 2(a), the first connection tab 100 may include a first short circuit part SP1. In some embodiments, the second connection tab 200 may include a second short circuit part SP2.

The first connection tab 100 may include a first-first end E1-1 and a first-second end E1-2. The first-first end E1-1 may be connected to an external power circuit. The first-second end E1-2 may be connected to the terminal part of the secondary battery.

The first short circuit part SP1 may be disposed on one region of the first connection tab 100. In some embodiments, the first short circuit part SP1 may be disposed between the first-first end E1-1 and the first-second end E1-2.

The first short circuit part SP1 may include a first cutting part CP1. The first cutting part CP1 is a region where the first connection tab is partially removed. Accordingly, a width of the first connection tab 100 may be reduced.

In some embodiments, the first connection tab 100 may have different widths depending on the location. In some embodiments, the first connection tab 100 may have a first width W1 in a region other than the first short circuit part SP1. In some embodiments, the first short circuit part SP1 may have a 1a width W1a and a 1b width W1b. The 1a width W1a and the 1b width W1b may be different. For example, the 1a width W1a may be smaller than the 1b width W1b. In some embodiments, the 1a width W1a may be smaller than the first width W1. In some embodiments, the 1b width W1b may be the same as or similar to the first width W1.

The 1a width W1a may be reduced by the first cutting part CP1. That is, the first short circuit part SP1 may have a region formed in which the width is reduced by the first cutting portion CP1. Accordingly, it is possible to prevent overcurrent from flowing into the secondary battery. In some embodiments, when overcurrent flows from the external power circuit to the secondary battery, the first electrode tab may be short-circuited by the first short circuit part SP1. That is, the first short circuit part SP1 may include a region having a small width by the first cutting part. Therefore, when overcurrent flows from the external power circuit to the secondary battery, the first connecting tab 100 may be cut off at the first short circuit part SP1. Accordingly, it is possible to block the overcurrent from flowing into the secondary battery. Accordingly, it is possible to prevent the secondary battery from being heated by the overcurrent. Therefore, since a fire of the secondary battery is prevented, the battery module according to the embodiment may have improved safety features.

The first short circuit part SP1 may have a set size. In some embodiments, the first connecting tab may have a first length L1. The first length L1 may be a distance between the first-first end E1-1 and the first-second end E1-2. In some embodiments, the first short circuit part SP1 may have a 1a length L1a. The 1a length L1a may be 10% or less of the first length L1. In some embodiments, the 1a length L1a may be 5% to 10%, 6% to 9%, or 7% to 8% of the first length L1.

If the 1a length L1a exceeds 10% of the first length L1, the strength of the first connecting tab may decrease. Accordingly, when welding the first connecting tab, a crack may occur in the first connecting tab. If the 1a length L1a is less than 5% of the first length L1, the size of the first short circuit part SP1 is reduced. Accordingly, when the overcurrent flows in the first connecting tab 100, the first connecting tab 100 may not be broken. Accordingly, the overcurrent may be transmitted to the secondary battery to cause a fire in the battery module.

Referring to FIG. 2(b), the second connecting tab 200 may include second ends E2. The second ends E2 may be connected to terminal parts of adjacent secondary batteries.

The second short circuit part SP2 may be disposed on one region of the second connecting tab 200. In some embodiments, the second short circuit part SP2 may be disposed between the second ends E2.

The second short circuit part SP2 may include a second cutting part CP2. The second cutting part CP2 is a region where the second connecting tab is partially removed. Accordingly, a width of the second connecting tab 200 may be reduced.

In some embodiments, the second connecting tab 200 may have different widths depending on the location. In some embodiments, the second connecting tab 200 may have a second width W2 in a region other than the second short circuit part SP2. In some embodiments, the second short circuit part SP2 may have a 2a width W2a and a 2b width W2b. The 2a width W2a and the 2b width W2b may be different. For example, the 2a width W2a may be smaller than the 2b width W2b. In some embodiments, the 2a width W2a may be smaller than the second width W2. In some embodiments, the 2b width W2b may be the same as or similar to the second width W2.

The 2a width W2a may be reduced by the second cutting part CP2. That is, the second short circuit part SP2 may have a region formed in which the width is reduced by the second cutting portion CP2. Therefore, it is possible to prevent overcurrent from flowing to the secondary battery. In some embodiments, when overcurrent flows from the external power circuit to the secondary battery, the second electrode tab may be short-circuited by the second short circuit part SP2. That is, the second short circuit part SP2 may include a region having a small width by the second cutting part. Therefore, when overcurrent flows to an adjacent secondary battery, the second connecting tab 200 may be cut off at the second short circuit part SP2. Accordingly, it is possible to block the overcurrent from flowing into the secondary battery. Accordingly, it is possible to prevent the secondary battery from being heated by the overcurrent. Therefore, since a fire of the secondary battery is prevented, the battery module according to the embodiment may have improved safety features.

The first width W1 and the second width W2 may be different. In some embodiments, the first width W1 may be larger than the second width W2. In some embodiments, the thickness of the first connection tab 100 may be larger than the thickness of the second connection tab 200.

The current flowing through the first connection tab may be larger than the current flowing through the second connection tab. Accordingly, the size of the first connection tab 100 may be larger than the size of the second connection tab. That is, the width and/or thickness of the first connection tab 100 may be larger than the second connection tab 100.

The 1a width W1a and the 2a width W2a may be different. In some embodiments, the 1a width W1a may be larger than the 2a width W2a. The current flowing through the first connecting tab may be greater than the current flowing through the second connecting tab. Therefore, the allowable current of the first connecting tab may be greater than the allowable current of the second connecting tab. Therefore, the overcurrent of the first connecting tab may be greater than the overcurrent of the second connecting tab. Therefore, the 1a width W1a may be greater than the 2a width W2a.

The second short circuit part SP2 may have a set size. In some embodiments, the second connecting tab may have a second length L2. The second length L2 may be a distance between the second ends E2. In some embodiments, the second short circuit part SP2 may have a 2a length L2a. The 2a length L2a may be 10% or less of the second length L2. In some embodiments, the second length L2a may be 5% to 10%, 6% to 9%, or 7% to 8% of the second length L2.

If the second length L2a exceeds 10% of the second length L2, the strength of the second connecting tab may decrease. Accordingly, when welding the second connecting tab, a crack may occur in the second connecting tab. If the second length L2a is less than 5% of the second length L2, the size of the second short circuit part SP2 decreases. Accordingly, when the overcurrent flows through the second connecting tab 200, the second connecting tab 200 may not be broken. Accordingly, the overcurrent may be transmitted to the secondary battery to cause a fire in the battery module.

The first length L1 and the second length L2 may be different. In some embodiments, the first length L1 may vary depending on the arrangement of the secondary batteries and the connection to the external power circuit.

The second short circuit part SP2 may be formed on at least one of the second connection tabs. In some embodiments, the battery module may include a second-first connection tab 210 connecting an anode terminal part of any one secondary battery to a cathode terminal part of another secondary battery adjacent to any one secondary battery. In some embodiments, the battery module may include a second-second connection tab 220 connecting a cathode terminal part of any one secondary battery to an anode terminal part of another secondary battery adjacent to any one secondary battery. At least one of the second-first connection tabs 210 or the second-second connection tabs 220 may include the second short circuit part SP2. For example, when a malfunction occurs in one of the secondary batteries, overcurrent may flow to adjacent secondary batteries. At least one of the second-first connection tabs 210 or the second-second connection tabs 220 may include the second short circuit part. Accordingly, overcurrent may be prevented from flowing to adjacent secondary batteries.

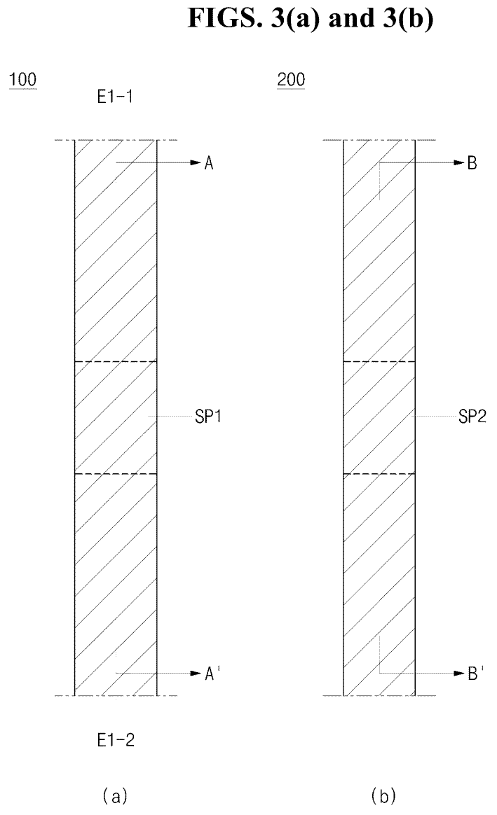

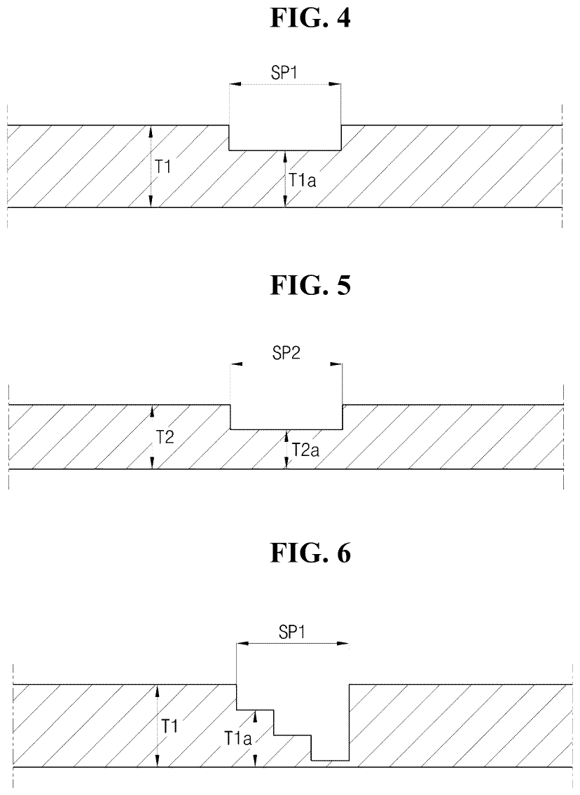

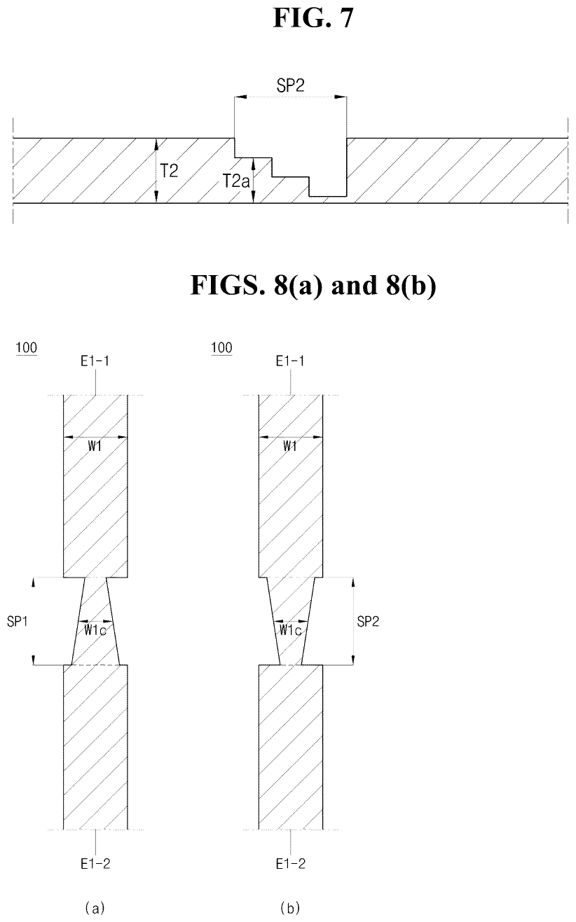

FIG. 3(a) and 3(b) are top views showing the connection tab of the battery module according to an embodiment of the present disclosure. FIG. 4 is a cross-sectional view taken along the A-A′ section of FIG. 3 an embodiment of the present disclosure. FIG. 5 is a cross-sectional view taken along the B-B′ section of FIG. 3 an embodiment of the present disclosure. FIG. 6 is a cross-sectional view taken along the A-A′ section of FIG. 3 an embodiment of the present disclosure. FIG. 7 is a cross-sectional view taken along the B-B′ section of FIG. 3 an embodiment of the present disclosure.

Referring to FIGS. 3 to 7, the short circuit part may have different thicknesses.

Referring to FIG. 3(a) and 4, the first connecting tab 100 may have a first thickness T1. In some embodiments, the first short circuit part SP1 may have a 1a thickness T1a. The 1a thickness T1a may be smaller than the first thickness T1.

Accordingly, when the overcurrent flows from the external power circuit to the secondary battery, the first electrode tab 100 may be short-circuited by the first short circuit part SP1. That is, the thickness of the first short circuit part SP1 is small. Accordingly, when the overcurrent flows to the first electrode tab 100, the first electrode tab 100 may be broken at the first short circuit part SP1. Therefore, the overcurrent may be blocked from being transmitted to the secondary battery. Accordingly, the secondary battery may be prevented from being heated by the overcurrent. Therefore, since the fire of the secondary battery is prevented, the battery module according to the embodiment may have improved safety features.

Referring to FIG. 3(b) and 5, the second connecting tab 200 may have a second thickness T2. In some embodiments, the second short circuit part SP2 may have a 2a thickness T2a. The 2a thickness T2a may be smaller than the second thickness T2.

The first thickness T1 and the second thickness T2 may be different. For example, the first thickness T1 may be greater than the second thickness T2. The current flowing through the first connection tab may be greater than the current flowing through the second connection tab. Therefore, the size of the first connection tab 100 may be greater than the size of the second connection tab. That is, the thickness of the first connection tab 100 may be greater than the thickness of the second connection tab 200.

The 1a thickness T1a and the 2a thickness T2a may be different. In some embodiments, the 1a thickness T1a may be greater than the 2a thickness T2a. The current flowing through the first connection tab may be greater than the current flowing through the second connection tab. Accordingly, the allowable current of the first connecting tab may be greater than the allowable current of the second connecting tab. Accordingly, the overcurrent of the first connecting tab may be greater than the overcurrent of the second connecting tab. Accordingly, the 1a thickness T1a may be greater than the 2a thickness T2a.

Accordingly, when the overcurrent flows between adjacent secondary batteries, the second electrode tab 200 may be short-circuited by the second short circuit part SP2. That is, the thickness of the second short circuit part SP2 is small. Accordingly, when the overcurrent flows to the second electrode tab 200, the second electrode tab 200 may be broken at the second short circuit part SP2. Accordingly, the overcurrent may be blocked from being transmitted to the secondary battery. Accordingly, the secondary battery may be prevented from being overheated by overcurrent. Therefore, since the fire of the secondary battery is prevented, the battery module according to the embodiment may have improved safety.

Referring to FIGS. 6 and 7, the thickness of the short circuit parts may change while extending in one direction. In detail, the thickness of the first short circuit part SP1 may change while extending in the longitudinal direction of the first connecting tab. For example, the 1a thickness T1a may decrease or increase while extending from the first-first end E1-1 to the first-second end E1-2. In some embodiments, the thickness of the second short circuit part SP2 may change while extending in the longitudinal direction of the second connecting tab. For example, the 2a thickness T2a may decrease or increase while extending in the longitudinal direction of the second connecting tab.

FIG. 8(a) and 8(b) are top views showing the connection tab of the battery module according to an embodiment of the present disclosure.

Referring to FIG. 8, the width of the short circuit parts may vary while extending in one direction. In some embodiments, the first short circuit part SP1 may have a 1c width W1c. The 1c width W1c may decrease or increase while extending from the first-first end E1-1 to the first-second end E1-2. Although not shown, the width of the second short circuit part SP2 may also decrease or increase while extending in the length direction of the second connection tab.

Accordingly, the short circuit parts may be short-circuited in a wide current range. That is, the allowable current range of the connection tab may be increased. For example, if the width or thickness of the short circuit part is the same, the connection tab may be short-circuited only when current A flows. However, since the width or thickness of the short circuit part varies, the connection tab may be short-circuited at current B to current A (current A>current B). Accordingly, the secondary battery may be applied to various electronic devices.

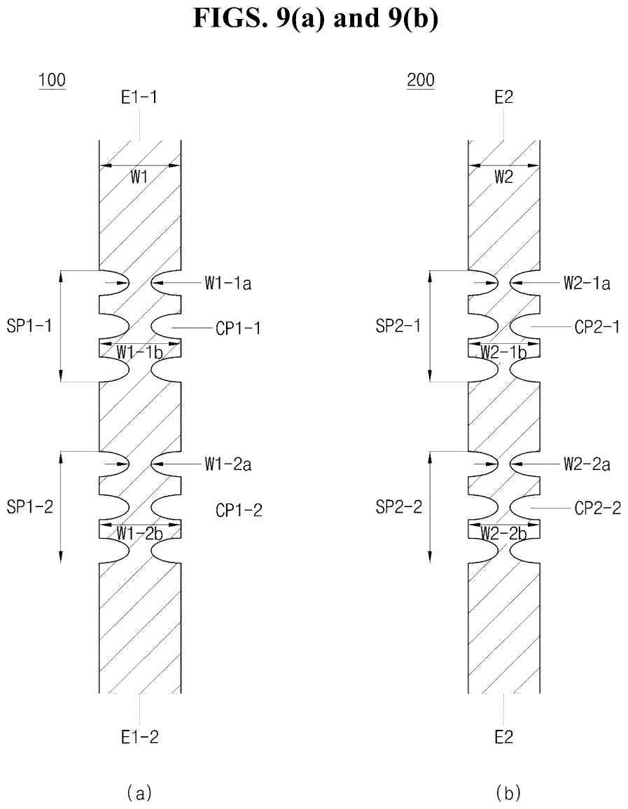

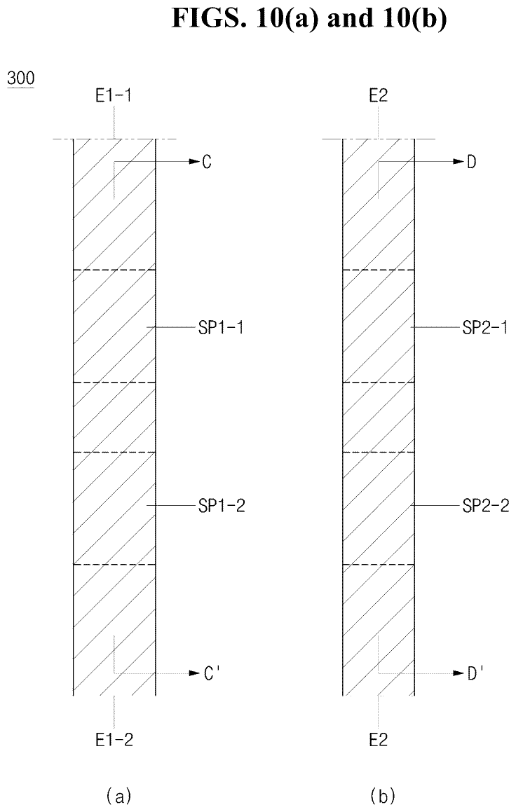

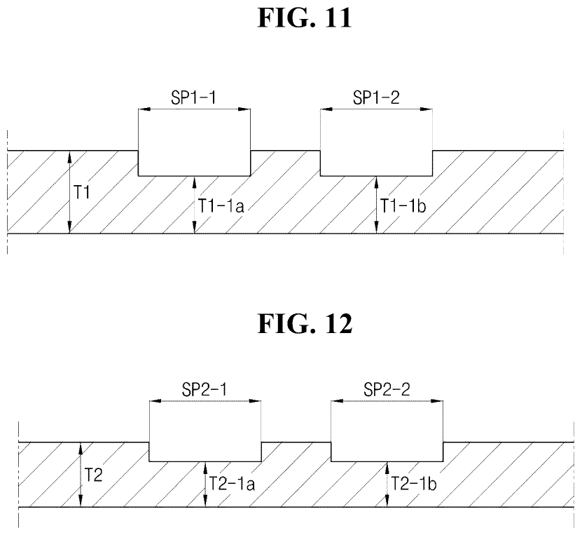

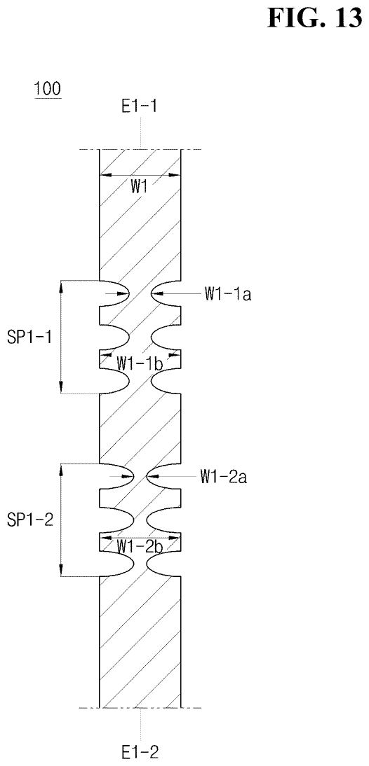

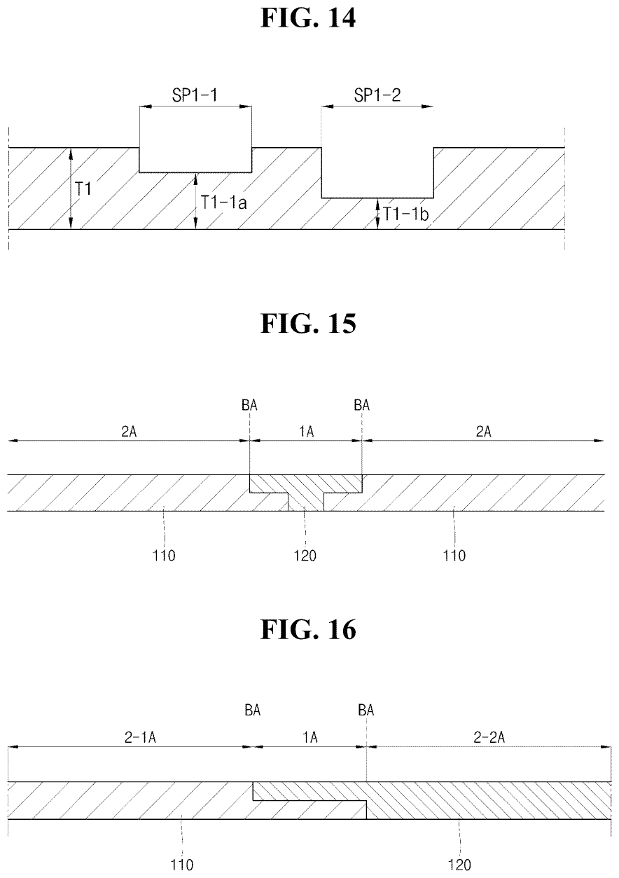

FIG. 9(a) and 9(b) are top views showing the connection tab of the battery module according to an embodiment of the present disclosure. FIG. 10(a) and 10(b) are top views showing the connection tab of the battery module according to an embodiment of the present disclosure. FIG. 11 is a cross-sectional view taken along the C-C′ section of FIG. 10 according to an embodiment of the present disclosure. FIG. 12 is a cross-sectional view taken along the D-D′ section of FIG. 10 according to an embodiment of the present disclosure. FIG. 13 Is a top view showing the connection tab of the battery module according to an embodiment of the present disclosure. FIG. 14 is a cross-sectional view taken along the C-C′ section of FIG. 10 according to an embodiment of the present disclosure.

Referring to FIG. 9(a) to 14, the connecting tab may include a plurality of short circuit parts.

Referring to FIG. 9(a), the first connecting tab 100 may include a first-first short circuit part SP1-1 and a first-second short circuit part SP1-2. The first-first short circuit part SP1-1 may include a first-first cutting part CP1-1, and the first-second short circuit part SP1-2 may include a first-second cutting part CP1-2. The sizes of the first-first cutting part CP1-1 and the first-second cutting part CP1-2 may be the same or similar. Therefore, the first-first short circuit part SP1-1 and the first-second short circuit part SP1-2 may have the same or similar sizes.

The first-first short circuit part SP1-1 may have a 1-1a width W1-1a and a 1-1b width W1-1b. The 1-1a width W1-1a may be smaller than the 1-1b width W1-1b. The 1-1b width W1-1b may be the same as or similar to the first width W1.

The first-second short circuit part SP1-2 may have a 1-2a width W1-2a and a 1-2b width W1-2b. The 1-2a width W1-2a may be smaller than the 1-2b width W1-2b. The 1-2b width W1-2b may be the same as or similar to the above first width W1.

When the overcurrent flows from the external circuit to the secondary battery, the first connecting tab 100 may be short-circuited in at least one of the first-first short circuit part SP1-1 or the first-second short circuit part SP1-2.

Referring to FIG. 9(b), the second connecting tab 200 may include a second-first short circuit part SP2-1 and a second-second short circuit part SP2-2. The second-first short circuit part SP2-1 may include a second-first cutting part CP2-1, and the second-second short circuit part SP2-2 may include a second-second cutting part CP2-2. The sizes of the second-first cutting part CP2-1 and the second-second cutting part CP2-2 may be the same or similar. Accordingly, the second-first short circuit part SP2-1 and the second-second short circuit part SP2-2 may have the same or similar sizes.

The second-first short circuit part SP2-1 may have a 2-1a width W2-1a and a 2-1b width W2-1b. The 2-1a width W2-1a may be smaller than the 2-1b width W2-1b. The 2-1b width W2-1b may be the same or similar to the second width W2.

The second-second short circuit part SP2-2 may have a 2-2a width W2-2a and a 2-2b width W2-2b. The 2-2a width W2-2a may be smaller than the 2-2b width W2-2b. The 2-2b width W2-2b may be the same as or similar to the second width W2.

When the overcurrent flows between the secondary batteries, the second connecting tab 200 may be short-circuited in at least one of the second-first short circuit part SP2-1 or the second-second short circuit part SP2-2.

Referring to FIG. 10(a) and 11, the first connecting tab 100 may include a first-first short circuit part SP1-1 and a first-second short circuit part SP1-2.

The first-first short circuit part SP1-1 may have a 1-1a thickness T1-1a, and the first-second short circuit part SP1-2 may have a 1-1b thickness T1-1b. The 1-1a thickness T1-1a and the 1-1b thickness T1-1b may be the same or similar. The 1-1a thickness T1-1a and the 1-1b thickness T1-1b may be smaller than the first thickness T1.

When the overcurrent flows from the external circuit to the secondary battery, the first connecting tab 100 may be short-circuited in at least one of the first-first short circuit part SP1-1 or the first-second short circuit part SP1-2.

Referring to FIG. 10(b) and 12, the second connecting tab 200 may include a second-first short circuit part SP2-1 and a second-second short circuit part SP2-2.

The second-first short circuit part SP2-1 may have a 2-1a thickness T2-1a, and the second-second short circuit part SP2-2 may have a 2-1b thickness T2-1b. The 2-1a thickness T2-1a and the 2-1b thickness T2-1b may be the same or similar. The 2-1a thickness T2-1a and the 2-1b thickness T2-1b may be smaller than the second thickness T2.

When the overcurrent flows between the secondary batteries, the second connecting tab 200 may be short-circuited in at least one of the second-first short circuit part SP2-1 or the second-second short circuit part SP2-2.

When the overcurrent flows through the first connecting tab or the second connecting tab, the short circuit parts may not be broken due to the time of the overcurrent or other variables. Accordingly, the connecting tabs may each include a plurality of short circuit parts. In some embodiments, the first connection tab 100 may be short-circuited at the first-first short circuit part SP-1 or the first-second short circuit part SP1-2. When the overcurrent flows through the first connection tab, the first-first short circuit part SP1-1 may not be short-circuited due to various variables. However, the first connection tab may be short-circuited at the first-second short circuit part SP1-2.

In some embodiments, the second connection tab 200 may be short-circuited at the second-first short circuit part SP2-1 or the second-second short circuit part SP2-2. When the overcurrent flows through the second connection tab, the second-first short circuit part SP2-1 may not be short-circuited due to various variables. However, the second connection tab may be short-circuited at the second-second short circuit part SP2-2.

Therefore, the battery module according to the embodiment may prevent overcurrent from being transmitted to the secondary battery. Therefore, the battery module according to the embodiment may have improved safety features.

The lengths of the short circuit parts may be different. In some embodiments, the length of the first-first short circuit part SP1-1 and the length of the first-second short circuit part SP1-2 may be different. In some embodiments, the length of the first-second short circuit part SP1-2 may be shorter than the length of the first-first short circuit part SP1-1. In some embodiments, the length of the second-first short circuit part SP2-1 and the length of the second-second short circuit part SP2-2 may be different. For example, the length of the second-second short circuit part SP2-2 may be shorter than the length of the second-first short circuit part SP2-1.

That is, based on the direction in which the current flows, the first-first short circuit part SP1-1 and the second-first short circuit part SP2-1 may be main short circuit parts, and the first-second short circuit part SP1-2 and the second-second short circuit part SP2-2 may be auxiliary short circuit parts.

The strength of the connecting tab may be reduced by the auxiliary short circuit part. Therefore, the length of the auxiliary short circuit part may be formed relatively short. Accordingly, damage to the connecting tab due to external impact may be prevented or reduced.

Referring to FIGS. 13 and 14, the sizes of the short circuit part may be different.

Referring to FIGS. 13 and 14, the first-first short circuit part SP1-1 and the first-second short circuit part SP1-2 may have different sizes.

In some embodiments, the 1-1b width W1-1b and the 1-2b width W1-2b may be the same as or similar to the first width W1. The 1-1a width W1-1a and the 1-2a width W1-2a may be smaller than the first width W1. The 1-1a width W1-1a and the 1-2a width W1-2a may be different. For example, the 1-1a width W1-1a may be larger than the 1-2a width W1-2a. In some embodiments, the first-first thickness T1-1 may be larger than the first-second thickness (T1-2).

The drawing shows the first connection tab, but the embodiment is not limited thereto. The second connection tab may also have different sizes of short circuit part like the first connection tab.

Accordingly, the short circuit part of the connection tab may be short-circuited in a wide current range. That is, the allowable current range of the connection tab may be increased. In some embodiments, if the sizes of the short circuit parts are the same, the connection tab may be short-circuited only when current A flows. However, since the widths or thicknesses of the short circuit parts are different, the connection tab may be short-circuited at current B to current A (current A>current B). Accordingly, the secondary battery may be applied to various electronic devices.

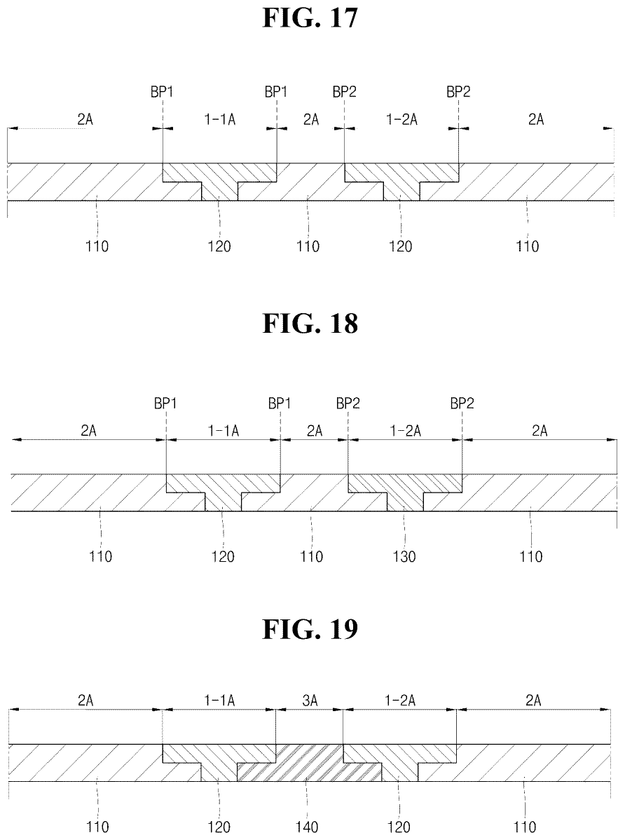

FIGS. 15 and 16 are cross-sectional views taken along the A-A′ section of FIG. 3 according to an embodiment of the present disclosure. FIGS. 17, 18, and 19 are cross-sectional views taken along the C-C′ section of FIG. 10 according to an embodiment of the present disclosure.

Referring to FIGS. 3, 15, and 16, the first connection tab 100 may include a first region 1A and a second region 2A. The first region 1A may be a short circuit part. The second region 2A may be a portion through which current flows.

The first connection tab 100 may include a conductive material. In some embodiments, the first connection tab 100 may include a metal. For example, the first connection tab 100 may include at least one of aluminum (Al), nickel (Ni), copper (Cu), or an alloy thereof.

Referring to FIG. 15, the first connecting tab 100 may include a plurality of metals. In some embodiments, the first connecting tab 100 may include a first metal 110 and a second metal 120. The first metal 110 and the second metal 120 may have different electrical resistances.

The first region 1A may include a first metal 110 and a second metal 120. In some embodiments, the second region 2A may include one metal. In some embodiments, the second region 2A may include the first metal 110.

Referring to FIG. 16, the first region 1A may include a plurality of metals. In some embodiments, the first region 1A may include a first metal 110 and a second metal 120.

The second region may include a plurality of regions. In some embodiments, the second region may include a second-first region 2-1A and a second-second region 2-2A. The second-first region 2-1A and the second-second region 2-2A may include one metal. For example, the second-first region 2-1A may include the first metal 110. The second-second region 2-2A may include the second metal 120.

The first metal 110 and the second metal 120 may include different metals. Metals have unique electrical resistances depending on their types. Accordingly, the electrical resistance of the regions may vary depending on the type of metal.

In some embodiments, referring to FIG. 15, the first region 1A has a first electrical resistance. And, the second region 2A has a second electrical resistance. The first region 1A includes two different metals. Accordingly, the first electrical resistance and the second electrical resistance may be different.

In some embodiments, referring to FIG. 16, the first region 1A has the first electrical resistance. In some embodiments, the second-first region 2-1A has a second-first electrical resistance. In some embodiments, the second-second region 2-2A has a second-second electrical resistance. The first region 1A includes two different metals. In some embodiments, the second-first region 2-1A and the second-second region 2-2A include different metals. Accordingly, the first electrical resistance, the second-first electrical resistance, and the second-second electrical resistance may be different.

Therefore, the first connecting tab 100 may include a region where electrical resistance changes while extending from the first-first end E1-1 to the first-second end E1-2. In some embodiments, the first connecting tab 100 may include boundary regions BA. The first region 1A and the second region 2A are separated by the boundary regions BA. That is, the first region 1A may be a region between the boundary regions BA. The electrical resistance of the first connecting tab 100 may change in the boundary regions BA. That is, the first region 1A may be a region in which resistance varies. That is, the first region 1A may be a variable resistance region of the first connecting tab 100.

Accordingly, it is possible to block overcurrent from being transmitted to the secondary battery. In some embodiments, when overcurrent flows from the external power circuit to the secondary battery, the first connecting tab may be short-circuited by the first region. The first region is a region in which resistance varies. Accordingly, when overcurrent flows to the first connecting tab, the first region may be momentarily heated by the resistance caused by the overcurrent. Accordingly, the first connecting tab may be broken in the first region. Accordingly, it is possible to prevent the secondary battery from being heated by the overcurrent. Therefore, since a fire of the secondary battery is prevented, the battery module according to the embodiment may have improved safety.

Referring to FIGS. 10, 17 to 19, the first region 1A may include a plurality of regions. In some embodiments, the first region 1A may include a first-first region 1-1A and a first-second region 1-2A.

The first-first region 1-1A and the first-second region 1-2A may include a plurality of metals. In some embodiments, the first-first region 1-1A and the first-second region 1-2A may include the first metal 110 and the second metal 120. And, the second region 2A may include one metal. In some embodiments, the second region 2A may include the first metal 110.

Therefore, the first connecting tab 100 may include a region in which the electrical resistance changes while extending from the first-first end E1-1 to the first-second end E1-2. In some embodiments, the first connecting tab 100 may include a first boundary region BA1 and a second boundary region BA2. The first-first region 1-1A and the second region 2A may be divided by the first boundary regions BA1. And, the 1-2 region 1-2A and the second region 2A may be divided by the second boundary regions BA2. The electrical resistance of the first connecting tab 100 may change in the first boundary region BA1 and the second boundary region BA2. That is, the first-first region 1-1A and the first-second region 1-2A may be regions where the resistance is changed. That is, the first-first region 1-1A and the first-second region 1-2A may be variable resistance regions of the first connection tab 100.

Accordingly, it is possible to block overcurrent from being transmitted to the secondary battery. In some embodiments, when overcurrent flows from the external power circuit to the secondary battery, the first connection tab may be short-circuited by the first-first region or the first-second region. Accordingly, the first connection tab may be broken in the first-first region or the first-second region. That is, the first connection tab may include at least two variable resistance regions. Accordingly, when one variable resistance region is defective, the first connection tab may short-circuit in another variable resistance region.

Therefore, the secondary battery may be prevented from being overheated by overcurrent. Therefore, since the fire of the secondary battery is prevented, the battery module according to the embodiment may have improved safety features.

The lengths of the first-first region 1-1A and the first-second region 1-2A may be the same or different. In some embodiments, the first-first region 1-1A may have the first-first length. The first-second region 1-2A may have the first-second length.

The first-first length and the first-second length may be the same.

In some embodiments, the first-first length and the first-second length may be different. For example, the first-first length may be longer than the first-second length. Based on the direction in which the current flows, the first-first region may be a main short circuit part, and the first-second region may be an auxiliary short circuit part. The strength of the connection tab may be reduced by the first-first region. Therefore, the length of the auxiliary short circuit part may be formed relatively short. Accordingly, damage to the connection tab due to external impact may be prevented or reduced.

The first-first region 1-1A and the first-second region 1-2A may include different metals. The first-first region 1-1A and the first-second region 1-2A may have different electrical resistances.

Referring to FIG. 18, the first-first region 1-1A may include the first metal 110 and the second metal 120. In some embodiments, the first-second region 1-2A may include the first metal 110 and a third metal 130. Since the first-first region 1-1A and the first-second region 1-2A include different metals, the electrical resistances of the first-first region 1-1A and the first-second region 1-2A may be different. Accordingly, the difference in electrical resistance between the first-first region 1-1A and the second region 2A may be different from the difference in electrical resistance between the first-second region 1-2A and the second region 2A.

Accordingly, the first region 1A may be short-circuited in a wide current range. That is, the allowable current range of the first electrode tab may be increased. For example, if the metals of the first-first region 1-1A and the first-second region 1-2A are the same, the first electrode tab may be short-circuited only when current A flows. However, the metals of the first-first region 1-1A and the first-second region 1-2A are different. Therefore, the first connecting tab includes a plurality of regions having different differences in electric resistance. Therefore, the first connecting tab may be short-circuited at current B to current A (current A>current B). Accordingly, the secondary battery may be applied to various electronic devices.

Referring to FIG. 19, the first connecting tab may further include a fourth metal 140. In some embodiments, the first connecting tab 100 may include a plurality of first regions 1-1A and 1-2A, the second region 2A, and the third region 3A.

The third region 3A may be disposed between the first-first region 1-1A and the first-second region 1-2A. That is, the first-first region 1-1A and the first-second region 1-2A may be disposed between the second region 2A and the third region 3A.

The third region 3A may include the fourth metal 140. The first-first region 1-1A and the first-second region 1-2A may be easily coupled by the third region 3A. That is, the third region 3A may be a buffer region.

The coupling strength of the first metal 110 and the second metal 120 may vary depending on the type of metal. Accordingly, there may be restrictions on the type of metal that can be used as the first connecting tab 100. The first connecting tab 100 may include a fourth metal 140 that can be easily combined with the second metal 120. Accordingly, the coupling of the first-first region 1-1A and the first-second region 1-2A may be facilitated. In some embodiments, the metal that can be used as the first connecting tab 100 may be diversified.

The battery module according to the embodiment may include a plurality of connecting tabs. The current of the external electric circuit may flow to the secondary battery through the first connecting tab. The current between the secondary batteries may flow through the second connecting tab.

The connecting tab may include a plurality of metals. Therefore, the electrical resistance of the connecting tab may vary depending on the location. In some embodiments, the connecting tab may have a region where the electrical resistance varies. Accordingly, the connecting tab may include the variable resistance region.

When the overcurrent flows through the connecting tab, the variable resistance region may be heated to a higher temperature than other regions. Accordingly, the connecting tab may be broken in the variable resistance region. Accordingly, the connecting tab may be short-circuited by the variable resistance region.

Accordingly, the connecting tab may be short-circuited before the overcurrent flows to the secondary battery. Accordingly, the battery module may be prevented from exploding due to the overcurrent. Accordingly, the battery module according to the embodiment may have improved safety.

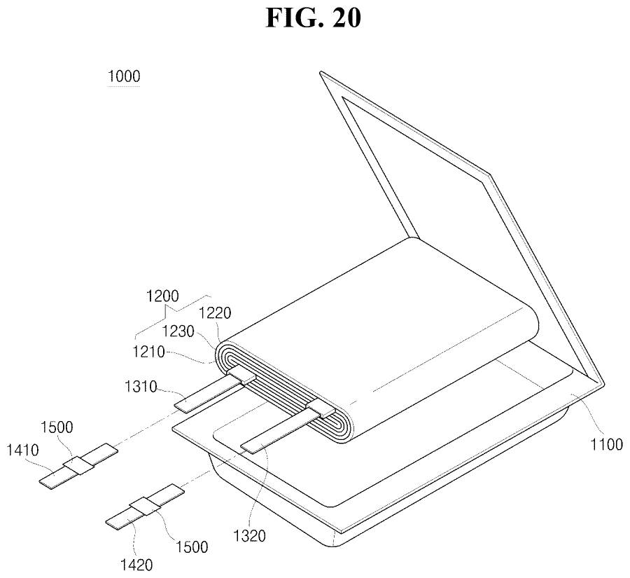

FIGS. 20, 21, and 22 show secondary batteries of various geometries according to an embodiment of the present disclosure.

Referring to FIG. 20, the battery module may include a pouch secondary battery. The secondary battery 1000 may include a case 1100 and an electrode assembly 1200 accommodated in the case 1100.

The electrode assembly 1200 may include a first electrode part 1210, a second electrode part 1220, and a separator 1230. The electrode assembly 1200 may be formed by winding or laminating the first electrode part 1210, the second electrode part 1220, and the separator 1230.

The first electrode part 1210 may include a first electrode current collector and a first electrode active material. The first electrode current collector may include a metal foil such as aluminum or an aluminum alloy. The first electrode active material may include a transition metal oxide. For example, the first electrode part 1210 may be a positive electrode.

The first electrode part 1210 may include a first electrode tab 1310. The first electrode active material is not disposed on the first electrode tab 1310. The first electrode tab 1310 may be welded to the first electrode current collector. In some embodiments, the first electrode tab 1310 may be formed integrally with the first electrode current collector. In some embodiments, the first electrode current collector may include a first uncoated portion on which the first electrode active material is not disposed. The first uncoated portion may be the first electrode tab 1310. The first electrode tab 1310 may include the same material as the first electrode current collector.

The second electrode part 1220 may include a second electrode current collector and a second electrode active material. The second electrode current collector may include a metal foil such as copper, a copper alloy, nickel, or a nickel alloy. The second electrode active material may include graphite or carbon. In some embodiments, the second electrode part 1220 may be a negative electrode.

The second electrode part 1220 may include a second electrode tab 1320. The second electrode active material is not disposed on the second electrode tab 1320. The second electrode tab 1320 may be welded to the second electrode current collector. In some embodiments, the second electrode tab 1320 may be formed integrally with the second electrode current collector. In some embodiments, the second electrode current collector may include a second uncoated portion in which the second electrode active material is not disposed. The second uncoated portion may be the second electrode tab 1320. The second electrode tab 1320 may include the same material as the second electrode current collector.

The separator 1230 prevents a short circuit between the first electrode part 1210 and the second electrode part 1230 while allowing movement of lithium ions therebetween. The separator may include, for example, a polyethylene film, a polypropylene film, a polyethylene-polypropylene film, or the like.

The first electrode tab 1310 may be connected to a first lead 1410 by welding. The second electrode tab 1320 may be connected to a second lead 1420 by welding. An insulating layer 1500 may be disposed on each of the first lead 1410 and the second lead 1420. The first lead 1410 and the second lead 1420 may be insulated from the case 1100 by the insulating layer 1500.

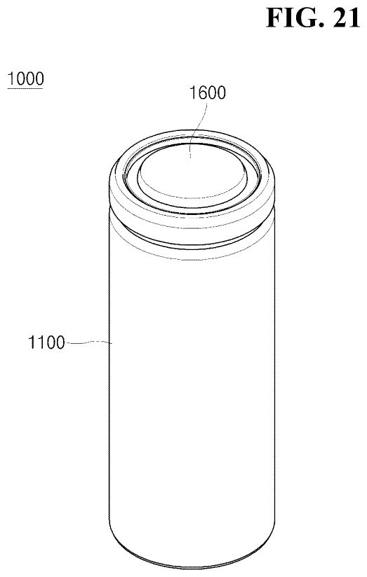

Referring to FIG. 21, the battery module may include a cylindrical secondary battery. The secondary battery may include a cylindrical case 1100 and a cap plate 1200 that seals the case 1100. The electrode assembly may be inserted into the in the case 1100 and sealed by the cap plate 1200.

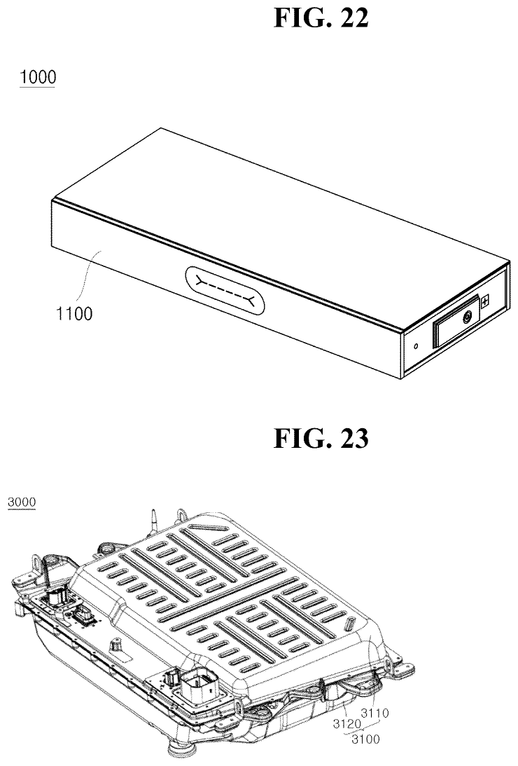

Referring to FIG. 22, the battery module may include a prismatic secondary battery. The secondary battery may include the case (1100) and an electrode assembly disposed in the case.

The secondary battery and battery module according to the embodiments may be used to manufacture a battery pack.

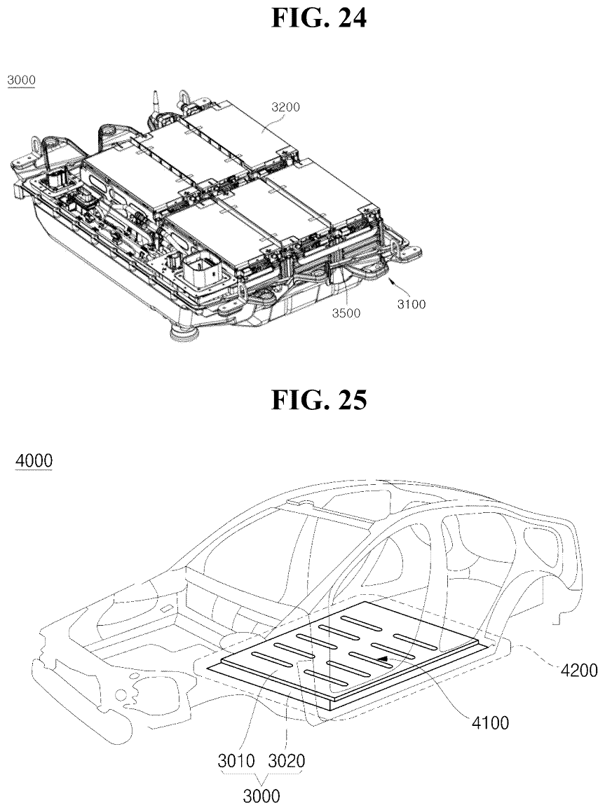

FIGS. 23 and 24 show a battery pack 3000 according to embodiments of the present disclosure. The battery pack 3000 may include a plurality of battery modules 3200 and a housing 3100 for accommodating the plurality of battery modules 3200. In some embodiments, the housing 3100 may include first and second housings 3110 and 3120 coupled in opposite directions through the plurality of battery modules 3200. The plurality of battery modules 3200 may be electrically connected to each other by using a bus bar 3500, and the plurality of battery modules 3200 may be electrically connected to each other in a series/parallel or series-parallel mixed method, thereby obtaining desired (e.g., required) electrical output. In the drawing, for convenience of illustration, parts such as bus bars, cooling units, and external terminals for electrical connection of secondary battery are omitted. In some embodiments, battery pack 3300 may be mounted in a vehicle. The vehicle may be or include, for example, an electric vehicle, a hybrid vehicle, or a plug-in hybrid vehicle. A vehicle may include a four-wheeled vehicle or a two-wheeled vehicle.

In FIG. 25, a battery pack 3000 may include a battery pack cover 3010, which is a part of a vehicle underbody 4100 and may correspond to the first housing, and a pack frame 3020, which is disposed under the vehicle underbody 4100 and may corresponding to the second housing. The battery pack cover 3010 and the pack frame 3020 may be, e.g., integrally formed with a vehicle floor 4200. The vehicle underbody 4100 separates the inside and outside of a vehicle, and the pack frame 3020 may be disposed outside the vehicle

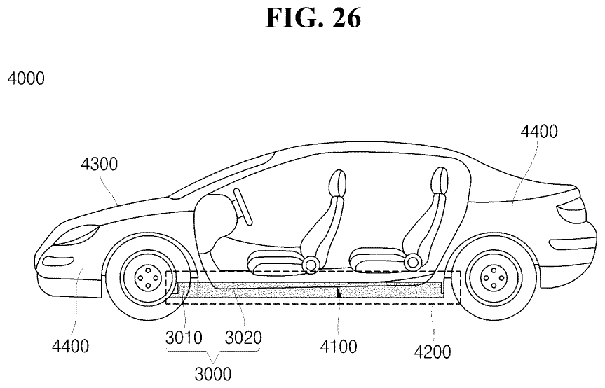

In FIG. 26, a vehicle 4000 may be formed by combining additional parts, such as a hood 4300 in front of the vehicle 4000 and fenders 4400 respectively located in the front and rear of the vehicle 4000 to a vehicle body part. The vehicle 4000 may include the battery pack 3000 including the battery pack cover 3010 and the pack frame 3020, and the battery pack 3000 may be coupled to the vehicle body part.

The above is only one embodiment for implementing a secondary battery according to the disclosure, the disclosure is not limited to the above embodiment, and there is a technical spirit of the disclosure to the extent that various modifications can be made by anyone having ordinary skill in the art to which the disclosure pertains without departing from the gist of the disclosure.

What is claimed is:

1. A battery module. comprising:
a plurality of a secondary battery comprising a terminal part and arranged in one direction;
a plurality of a first connection tab connecting the plurality of the secondary battery to an external power circuit;
a plurality of a second connection tab connecting the plurality of the secondary battery; and
a housing fixing the plurality of the secondary battery,
wherein the first connection tab comprises a first short circuit part comprising the first cutting part,
wherein the second connection tab comprises a second short circuit part comprising a second cutting part, and
wherein the first connection tab has a size greater than a size of the second connection tab.

2. The battery module as claimed in claim 1, wherein the first connecting tab has a first width in a region other than the first short circuit part, wherein the first short circuit part has a 1a width formed by the first cutting part, and wherein the 1a width is less than the first width.

3. The battery module as claimed in claim 2, wherein the second connecting tab has a second width in a region other than the second short circuit part, wherein the second short circuit part has a 2a width formed by the second cutting part, and wherein the 2a width is less than the second width.

4. The battery module as claimed in claim 3, wherein the first width is greater than the second width.

5. The battery module as claimed in claim 3, wherein the 1a width is greater than the 2a width.

6. The battery module as claimed in claim 1, wherein the first connecting tab has a first length, and wherein a length of the first short circuit part is 5% to 10% of the first length.

7. The battery module as claimed in claim 6, wherein the second connecting tab has a second length, and wherein a length of the second short circuit part is 5% to 10% of the second length.

8. The battery module as claimed in claim 7, wherein the first length and the second length are different.

9. The battery module as claimed in claim 1, wherein at least one of the plurality of the second connecting tab comprises a short circuit part.

10. The battery module as claimed in claim 1, wherein the first connecting tab has a first thickness, wherein the first short circuit part has a 1a thickness, and wherein the 1a thickness is less than the first thickness.

11. The battery module as claimed in claim 10, wherein the second connecting tab has a second thickness, wherein the second short circuit part has a 2a thickness, and wherein the 2a thickness is less than the second thickness.

12. The battery module as claimed in claim 11, wherein the first thickness is greater than the second thickness, and wherein the 1a thickness is greater than the 2a thickness.

13. The battery module as claimed in claim 10, wherein the 1a thickness varies while extending in a longitudinal direction of the first connecting tab, and wherein the 2a thickness varies while extending in a longitudinal direction of the second connecting tab.

14. The battery module as claimed in claim 1, wherein at least one of the plurality of the first connecting tab or at least one of the plurality of the second connecting tab comprises a plurality of a short circuit part.

15. The battery module as claimed in claim 14, wherein a width or a thickness of any two or more of the plurality of the short circuit part are different.

16. A battery module, comprising:
a plurality of a secondary battery comprising a terminal part and arranged in one direction;
a plurality of a first connection tab connecting the plurality of the secondary battery to an external power circuit;
a plurality of a second connection tab connecting the plurality of the secondary battery; and
a housing fixing the plurality of the secondary battery,
wherein the first connection tab or the second connection tab comprises a variable resistance region, and
wherein an electrical resistance of the variable resistance region is different from an electrical resistance of other regions of the first connection tab or the second connection tab.

17. The battery module as claimed in claim 16, wherein the first connecting tab or the second connecting tab further comprises a first region and a second region, wherein an electrical resistance of the first region and an electrical resistance of the second region are different, and wherein the first region comprises the resistance variable region.

18. The battery module as claimed in claim 17, wherein the first region comprises a first metal and a second metal, wherein the first metal and the second metal are different, wherein the second region comprises the first metal, and wherein each of the first metal and the second metal comprise aluminum, copper, or nickel.

19. The battery module as claimed in claim 17, wherein the first region comprises a first-first region and the first-second region.

20. The battery module as claimed in claim 19, wherein a length of the first-first region is greater than a length of the first-second region.
